(19) United States
(12) Patent Application Publication
(10) Pub. No.: US 2018/0214841 A1
(43) Pub. Date: Aug. 2, 2018

(54) METHOD AND APPARATUS FOR PARTIALLY SOLIDIFYING A METHANE COMPRISING STREAM

(71) Applicant: SHELL OIL COMPANY, Houston, TX (US)

(72) Inventors: Kai Jürgen FISCHER, Amsterdam (NL); Marcel Filip DABKOWSKI, Rijswijk (NL); Joshua ETKIND, Rijswijk (NL); Ancuta Ioana HULEA, Rijswijk (NL); Laurens Joseph Arnold Marie VAN CAMPEN, Amsterdam (NL); Raymond Petrus Henricus Maria BERGMANN, Amsterdam (NL)

(21) Appl. No.: 15/748,551

(22) PCT Filed: Jul. 28, 2016
(86) PCT No.: PCT/EP2016/068038

§ 371 Date: Jan. 29, 2018

(30) Foreign Application Priority Data
Jul. 31, 2015 (EP) 15179342.9

(51) Int. Cl. B01J 19/06; F25J 1/00; F25J 1/02

(52) U.S. Cl. CPC B01J 19/06; F25J 1/0022; F25J 1/0254; F25J 1/0264; F25J 2205/20; F17C 2223/0184; F25J 2220/64; F25J 2230/60; F25J 2290/34; F17C 2221/033; F25J 2210/04

(57) ABSTRACT

The invention relates to a method and apparatus for partially solidifying a methane comprising stream. The method comprises—providing a liquid methane comprising stream (30) at a first pressure (P1),—passing the liquid methane comprising stream (30) to a slush vessel (300) which is kept at a second pressure (P2), the second pressure (P2) being lower than the first pressure (P1), thereby cooling and at least partially solidifying the methane comprising stream (30) generating a methane comprising slush, and—collecting the methane comprising slush.

The present invention relates to a method and apparatus for partially solidifying a methane comprising stream.

Methane comprising streams can be derived from a number of sources, such as natural gas or petroleum reservoirs, or from a synthetic source such as a Fischer-Tropsch process. In this text the term natural gas is used to refer to methane comprising streams originating from any source. The term methane comprising stream is used in this text to refer to streams comprising at least 50 mol % methane. The term in particular relates to natural gas streams.

Natural gas is a useful fuel source, as well as a source of various hydrocarbon compounds. It is often desirable to liquefy natural gas in a liquefied natural gas (LNG) plant at or near the source of a natural gas stream to enable compact storage of the natural gas and/or efficient transport of the natural gas over long distances. Natural gas can be more easily stored and transported in a liquid form than in a gaseous form because it occupies a smaller volume.

Liquefied natural gas plants are well known in the field and comprise the following processing steps

optionally treating the methane comprising stream by removing impurities in a treating stage, such as water, acid gases, mercury,

optionally removing natural gas liquids from the methane comprising stream in a NGL stage, such as ethane, propane, butane and heavier components,

cooling the methane comprising stream in one or more cooling stages, for instance a pre-cooling stage and a main cooling stage, and

optionally flashing the methane comprising stream in an end-flash stage and,

optionally, storing the liquefied natural gas in a storage tank.

A drawback of liquefied natural gas is that boil off gas is created due to heat ingress. This limits the amount of time the liquefied natural gas can be stored.

Methods of producing a methane comprising slush or slush LNG, being a mixture of solid and liquid natural gas, are known. The term slush is used in this text to indicate a pumpable liquid-solid mixture.

Slush LNG has the advantage that less or no boil off gas is produced. Also, the density of slush LNG is higher than the density of liquid natural gas allowing more molecules to be stored and transported in a given volume.

Japanese patent document JP2003314954 describes a slush LNG manufacturing method in which solid LNG and liquid LNG are mixed. A liquid nitrogen tank is mounted in a liquefied natural gas tank, and a solid matter obtained by solidifying the liquefied natural gas is produced on a heat transfer face of a surface of the liquid nitrogen tank and scraped off by an auger to be mixed with the liquefied natural gas. JP2003314954 has the disadvantage that it requires substantial and complex hardware, which also makes it difficult to scale up this process in an economically advantageous manner. Furthermore, an additional refrigeration cycle for the nitrogen refrigerant is needed which requires a relatively large amount of cooling energy.

NBS Report 9758, Slush and boiling methane characterisation, by C. f. Sindt et al (U.S. Department of Commerce, National Bureau of Standards, Institute for basic standards, Boulder, Colo. 80302 (Jul. 1, 1970) describes an experimental, batchwise production apparatus for producing slush LNG. Batchwise production of slush LNG is not suitable for use in a continuous manufacturing method.

EP1876404A1 describes an apparatus for producing nitrogen slush. U.S. Pat. No. 4,009,013 describes a process for preparing fine-grained slush of low-boiling gasses, such as e.g. nitrogen or hydrogen.

Methods described above suffer from the disadvantage that they have limitations when it comes to upscaling to industrial processes.

U.S. Pat. No. 3,581,511 describes a gas liquefaction system wherein subcooled liquid natural gas, or slush natural gas, or even solid natural gas can be produced by adding an additional heat exchanger and separators. The refrigerant composition that is proposed includes nitrogen, helium and/or hydrogen, as well as hydrocarbons. U.S. Pat. No. 3,581,511 has the disadvantage that an additional heat exchanger as well as an additional refrigerant is needed.

It is an object to provide a method and apparatus that allows for continuous production of methane comprising slush, without the need of substantial and complex additional hardware, such as an additional refrigerant cycle.

The present invention provides a method of partially solidifying a methane comprising stream, the method comprising

providing a liquid methane comprising stream (30) at a first pressure (P1),

passing the liquid methane comprising stream (30) to a slush vessel (300) which is kept at a second pressure (P2), the second pressure (P2) being lower than the first pressure (P1), thereby cooling and at least partially solidifying the methane comprising stream (30) generating a methane comprising slush, and

collecting the methane comprising slush.

The slush comprises solid methane and liquid methane. The solid methane is present as solid particles. The solid particles primarily comprise methane, e.g. at least 50 mol %, 80 mol % or at least 95 mol % methane.

The methane comprising slush is a mixture of solid and liquid formed out of the methane comprising stream and may also be referred to as slush LNG or slurry LNG. Above the slush a methane comprising vapour phase will be formed.

The first pressure may typically be substantially equal to the atmospheric or ambient pressure (Pₐₜₘ). The term substantial is used in this context to indicate that the first pressure is within 25%, or within 10%, or at least within 5% from or above the atmospheric or ambient pressure. The first pressure may for instance be in the range of 50-250 mbarg.

Alternatively, the first pressure may be equal or greater than the atmospheric or ambient pressure, e.g. greater than 2 bar, greater than 10 bar or even greater than 12 bar. According to an example, the first pressure may be 15 bar. At such a pressure, the temperature of the liquid methane comprising stream may be −115° C.

Of course, it will be understood that the actual pressure may vary, as it may need to be increased in order to transport/pump the liquid methane comprising stream and decreases as a result of pressure losses during transport (typically through a conduit). Despite the above identified variations, the second pressure (P2) is lower than the first pressure (P1), also when taking into account pressure variations in the first pressure.

The first pressure may be controlled to control the expansion process and/or enhance the expansion cooling effect. The slushification process will depend on the pressure difference between the first and second pressure in combination with the nozzle or spray head or the like used to introduce the stream in the slush vessel. These parameters will influence the solid fraction and particle size created. The method may therefore comprise controlling, including actively controlling and constantly or regularly adjusting, the first pressure. The first pressure may be adjusted in response to one or more parameters measured from the slush.

The term methane comprising stream is used to refer to a hydrocarbon stream which primarily consists of methane, so comprises at least 50 mol % of methane. The methane comprising stream may comprise at least 75% mol %, at least 90 mol % or even at least 95 mol % methane.

The methane comprising stream may further comprise heavier carbons, such as ethane, propane, (iso-)butane, (iso-)pentane. Typically, the mol fractions of heavier components are smaller than the mol fractions of lighter components.

The methane comprising stream typically comprises at least 75 mol % of methane and ethane, typically more than 90 mol % or even 95% mol % of methane and ethane, the methane fraction being at least 50 mol %.

The methane comprising stream may further comprise a fraction of nitrogen.

The methane comprising stream has a unique triple point pressure and triple point temperature depending on the exact composition. A person skilled in the art will be able to determine the exact triple point pressure and triple point temperature for a given composition.

The second pressure may be varied during execution of the method, but is at least part of the time at or below the triple point pressure of the methane comprising stream being passed to the slush vessel, so that vaporization of a portion of the methane comprising stream is enabled for cooling and solidifying the methane comprising stream, i.e. removing of sensible heat and latent heat of crystallization during solid formation.

The methane comprising stream is typically cooled to its triple point at which solids, liquids and vapors coexist. The methane comprising slush is typically collected in a slush vessel or tank. A liquid-solid mixture will thereby be formed with a vapour phase above.

So, the method comprises passing the liquid methane comprising stream (30) to a slush vessel (300) which is kept at a second pressure (P2), thereby cooling and at least partially solidifying and evaporating the methane comprising stream (30). The evaporation will withdraw enthalpy thereby cooling the non-evaporated portion of the stream (auto-thermal process). Together with the Joule Thompson effect created when introducing the liquid methane comprising stream in the slush vessel creates sufficient cooling to reach the triple point temperature.

According to a further aspect, there is provided an apparatus for partially solidifying a methane comprising stream, the apparatus comprising

a feed conduit arranged to receive a liquid methane comprising stream (30) at a first pressure (P1),

a slush vessel (300) which is in fluid communication with the feed conduit to receive the liquid methane comprising stream (30),

a vapour withdrawing device being in fluid communication with the slush vessel (300) to withdraw vapour from the slush vessel and keep the slush vessel at a second pressure (P2), the second pressure (P2) being lower than the first pressure (P1), and the second pressure being substantially equal to or lower than the triple point pressure of the methane comprising stream.

The apparatus may comprise one or more throttle valves or spray nozzles (301) positioned in the slush vessel (300) to receive the liquid methane comprising stream (30) from the feed conduit and spray cool the methane comprising stream into the slush vessel (300) to, in use, create a methane comprising slush. The slush vessel (300) may comprise an internal mixer to keep the methane comprising slush pumpable.

The slush vessel is therefore a vessel able to withstand an underpressure with respect to its environment, the underpressure being equal to ambient pressure minus the triple point pressure of the methane comprising stream. The vessel may therefore also be referred to as a vacuum vessel.

According to a further aspect there is provided a mixture of solid methane comprising hydrocarbon and liquid methane comprising hydrocarbon obtained by the above described method or apparatus.

Preferably, the mixture of solid methane comprising hydrocarbon and liquid methane comprising hydrocarbon has a solid fraction in the range of 30 weight %-70 weight %, preferably in the range of 30-50 weight % or 40-60 weight %.

The invention will be further illustrated hereinafter, using examples and with reference to the drawing in which;

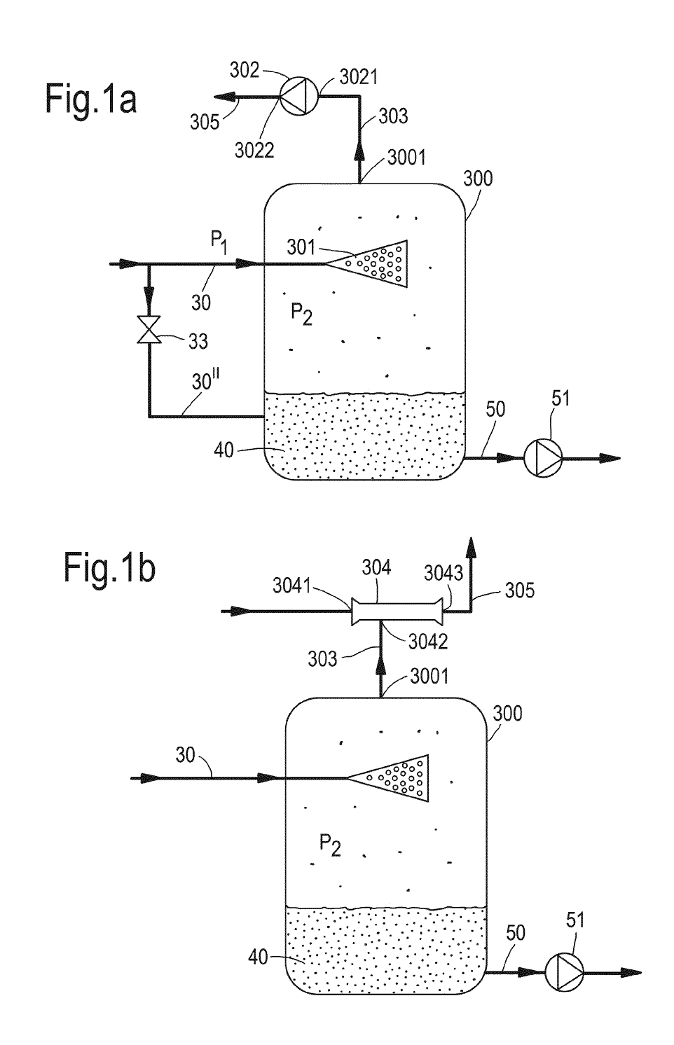

FIGS. 1a-1b schematically show line-up according to embodiments,

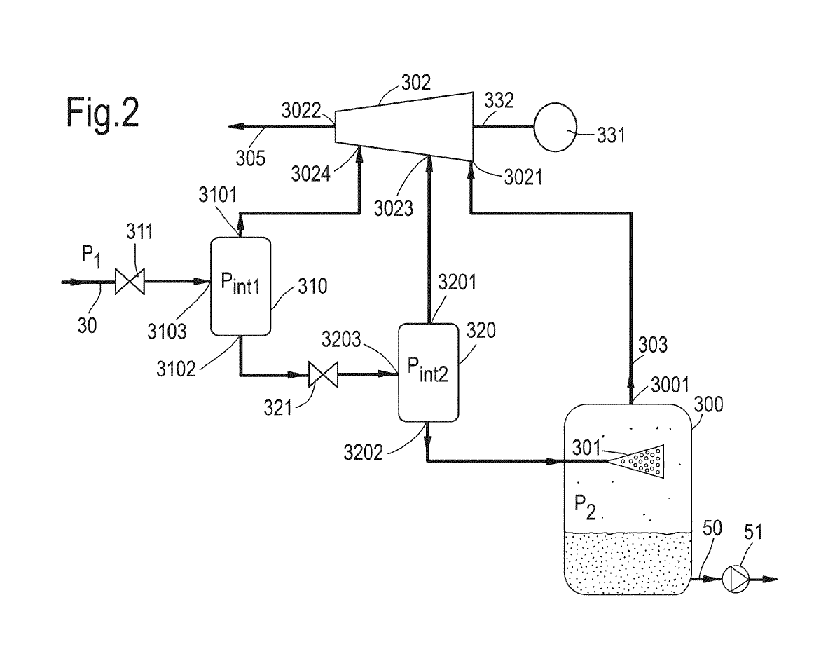

FIG. 2 schematically shows an alternative embodiment,

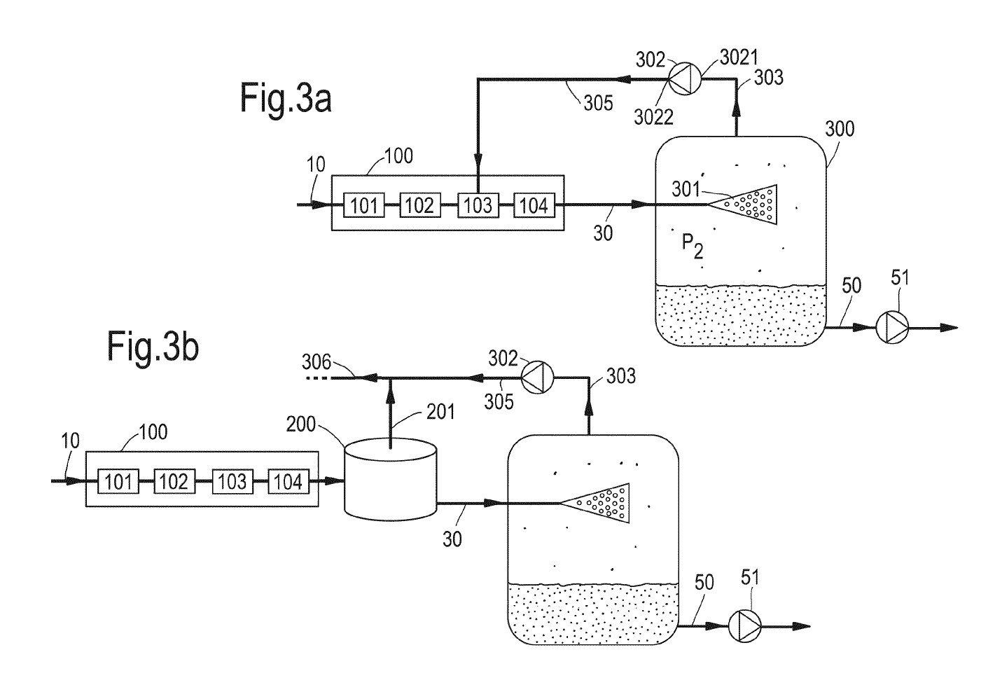

FIGS. 3a-b schematically show two different embodiments of integration with a liquefaction plant, and

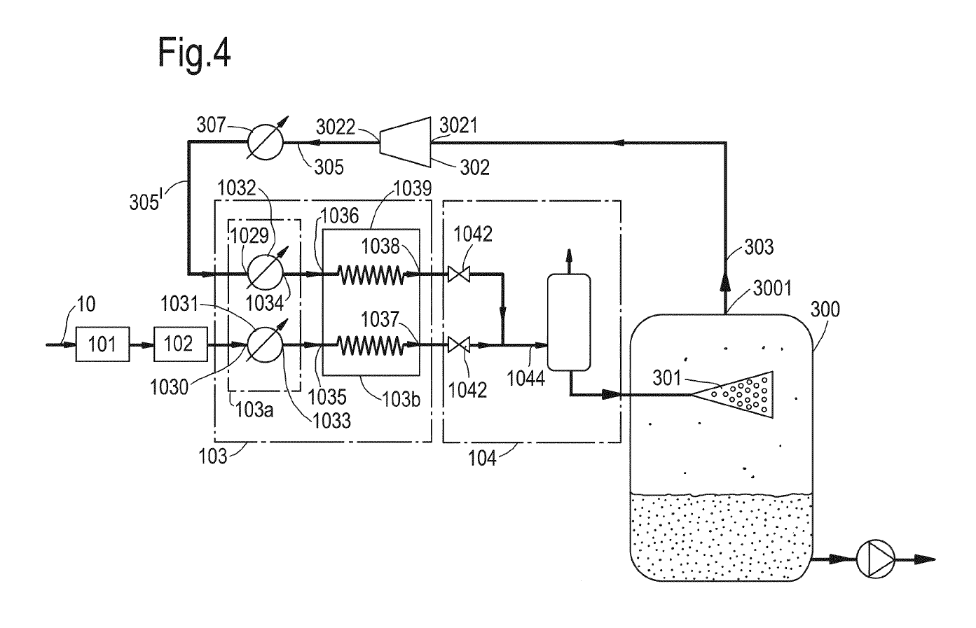

FIG. 4 schematically show a more detailed integration with a liquefaction plant.

In these figures, same reference numbers will be used to refer to same or similar parts. Furthermore, a single reference number will be used to identify a conduit or line as well as the stream conveyed by that line.

It is presently proposed to provide a method of creating a methane comprising slush, i.e. a mixture of liquid and solid comprising methane by expanding a liquid methane comprising stream to its triple point conditions, such that a portion of the liquid methane comprising stream vaporizes, an other portion of the liquid methane comprising stream cools down and as a result solidifies and solid particles are formed and a remainder of the liquid methane comprising stream remains liquid. This way a methane comprising slush is created which is still pumpable, with a vapour fraction being present above the slush.

A liquid methane comprising stream is provided at a first pressure, is passed to a slush vessel which is kept at a second pressure, the second pressure being lower than the first pressure, thereby cooling and at least partially solidifying the methane comprising stream and a methane comprising slush is collected.

The liquid methane comprising stream could be obtained from a storage tank, a liquefaction plant or liquefaction train, from an end-flash stage of a liquefaction plant or train or directly from a heat exchanger (main cryogenic heat exchanger) comprised by a liquefaction plant or liquefaction train.

FIG. 1a schematically shows an embodiment, comprising a conduit 30, in use, conveying a liquid methane comprising stream 30 at a first pressure P1. The conduit 30 may also be referred to as a feed conduit 30 or slush vessel feed conduit 30.

The conduit 30 is arranged to transport a cryogenic liquid, i.e. a liquid with a temperature below −100° C., or even below −150° C. The conduit is in particular arranged to transport liquefied natural gas at a temperature below −100° C. or below −150° C.

The conduit 30 is with one end in fluid communication with a supply of liquid methane and is with another end in fluid communication with a slush vessel 300 which is kept at a second pressure P2, being lower than the first pressure P1.

According to an embodiment the second pressure P2 in the slush vessel 300 is substantially equal to or lower than the triple point pressure of the methane comprising stream.

The first pressure is typical 1 bar or higher. The second pressure is below 1 bar and may be equal to or below 0.44 bar, equal to or below 0.12 bar (P₂≤0.12 bar), for instance equal to or below 0.05 bar (P₂≤0.05 bar). It will be understood that the exact triple point conditions depend on the composition of the liquid methane comprising stream 30 at the first pressure P1. The person skilled in the art will be able to determine the exact triple point conditions based on a given composition.

As a result, the temperature in the slush vessel is substantially equal to or below the triple point temperature of the methane comprising stream.

The term substantially equal is used to indicate that the pressure and temperature are at least within 10%, for instance within 5% or within 2% from the triple point pressure and triple point temperature.

The method may further comprise controlling the second pressure by varying or cycling the second pressure in time to thereby control a solid fraction being produced and to thereby control a solid fraction in the mixture 40 collected. This will be explained in more detail further below. This ensures that a pumpable mixture of solid and liquid is created in the slush vessel. For a typical methane comprising stream comprising 100% methane, the triple point conditions are −182.47° C. (90.68 K) at 0.11688 bar.

The slush vessel is therefore a vessel able to withstand a certain underpressure with respect to its environment and may therefore also be referred to as a vacuum vessel.

According to an embodiment passing the liquid methane comprising stream 30 to the slush vessel 300 which is kept at the second pressure P2 is done by spray cooling the methane comprising stream 30.

Spray cooling can be done using one or more parallel throttle valves or spray nozzles 301 positioned in the slush vessel 300.

FIG. 1a shows a spray nozzle 301 positioned inside the slush vessel 300 which is in fluid communication with conduit 30 to receive the liquid methane comprising stream.

A throttle valve or spray nozzle comprise one or more openings through which the liquid methane comprising stream can expand adiabatically, thereby cooling and evaporating the methane comprising stream.

At the same time, the throttle valve or spray nozzle will create droplets or a mist. The type of the throttle valve or spray nozzle or alternative expansion device in combination with pressure of the inlet stream will influence the droplet size and thus the size of the solid particles that are generated.

Instead of cycling the second pressure as explained above, other methods may be applied to control the solid fraction in the mixture 40.

According to an embodiment, an additional liquid methane comprising stream can introduced in the slush vessel 300 to be directly mixed with the slush inside the slush vessel 300.

By controlling the flow rate and/or the pressure and/or the temperature of the additional liquid methane comprising stream the solid fraction and the slush composition can be controlled. The additional liquid methane comprising stream may be obtained from any suitable source, including a split-off from the liquid methane comprising stream 30. The additional liquid methane comprising stream may be sub-cooled before entering the slush vessel 300 thereby obtaining a sub-cooled additional liquid methane comprising stream, for instance having a temperature in the range of −165° C. to −180° C.

According to an embodiment, a part of the liquid methane comprising stream 30 can be split-off to form a by-pass stream 30″, the by-pass stream 30″ being directly forwarded to the slush vessel 300 by-passing the throttle valves or spray nozzles 301. This is shown in FIG. 1a. The by-pass stream 30″ may be subcooled before being introduced into the slush vessel 300 (not shown).

The additional liquid methane comprising stream, e.g. the by-pass stream 30″, preferably enters the slush vessel 300 at a level below a level at which the remaining liquid methane comprising stream from which the by-pass stream is split-off enters the slush vessel 300. Preferably, the additional liquid methane comprising stream, e.g. the by-pass stream 30″, enters the slush vessel 30 at a level below the surface of the methane comprising slush. A controllable splitter may be provided at the split-off or a controllable valve may be provided in the by-pass conduit 30″ to control the flow rate of the by-pass stream 30″.

The by-pass stream 30″ is conveyed to the slush vessel 300 via a by-pass conduit 30″. The by-pass conduit 30″ establishes fluid communication between the slush vessel 300 and the conduit 30 conveying the liquid methane comprising stream 30 at a first pressure P1.

A flow rate control device, such as a controllable valve 33, may be present to control the flow rate of the by-pass stream 30″ and thereby actively control the solid fraction in the mixture 40 during use in response to a measured solid fraction. The by-pass stream 30″ may be applied in all further embodiments described below, as will be understood by a skilled person.

The additional liquid methane comprising stream may be employed in all embodiments described.

An outlet conduit 50 may be provided which is in fluid communication with a bottom part of the slush vessel 300 to convey methane comprising slush towards a destination, such as a carrier vessel by a pump 51.

According to an embodiment the method comprises

withdrawing a vapour stream from a top outlet of the slush vessel 300 using a vapour withdrawing device, such as a compressor 302 and/or an eductor 304.

FIG. 1a shows a top conduit 303 which is with one end in fluid communication with a top outlet 3001 of the slush vessel 300 and with another end in fluid communication with a compressor or pump 302.

The compressor has a compressor inlet 3021 and a compressor outlet 3022, wherein the compressor inlet 3021 is in fluid communication with the top outlet 3001 of the slush vessel 300.

The compressor, being a gas compressor, is arranged to withdraw a vapour top stream from the slush vessel and thereby control the second pressure P2 in the slush vessel 300. The compressor generates a vapour outlet stream 305.

The operating parameters of the compressor may be controlled, such as the revolutions per minute, to control the second pressure in the slush vessel. Controlling the compressor may be done in response to one or more measured parameters as will be explained in more detail. For instance in response to a pressure reading obtained by a pressure sensor which provides an indication of the second pressure. The pressure sensor may be arranged to measure the second pressure in the slush vessel directly, or measure a pressure downstream of the slush vessel to obtain an indirect indication of the second pressure.

Instead of or in addition to the compressor an eductor 304 may be used to withdraw the vapour stream from the top outlet of the slush vessel 300. An example of this is shown in FIG. 1b. The method may comprise

taking a side-stream 30′ from the liquid methane comprising stream 30 and passing the side-stream 30′ as motive stream to the eductor 304, and withdrawing the vapour stream 303 as suction stream of the eductor 304, obtaining a vapour outlet stream 305.

FIG. 1b shows a side-stream conduit 30′ which is with one side in fluid communication with conduit 30 and with another end in fluid communication with a motive stream inlet 3041 of the eductor 304. Top conduit 303 conveying the vapour stream is with one end fluid communication with the top outlet 3001 of the slush vessel 300 and with the other end in fluid communication with a suction inlet 3042 of the eductor 304.

The eductor 304 comprises an outlet 3043 conveying a vapour outlet stream 305.

A splitter 31 may be provided to control the flow rate of the side-stream 30′.

It will be understood that the by-pass stream via the by-pass conduit 30″ as discussed above with reference to FIG. 1a, may also be applied to the embodiment described with reference to FIG. 1b, although not shown in FIG. 1b.

The methane comprising slush 40 comprises a solid fraction and a liquid fraction.

According to an embodiment the second pressure P2 is controlled to control a solid fraction of the methane comprising slush in the slush vessel 300.

The solid fraction is preferably controlled to prevent the mixture of liquid and solid methane comprising hydrocarbon from becoming too viscous, making pumping difficult and prevent the mixture of liquid and solid methane from becoming too fluid, resulting in a sub-optimal density.

Controlling the second pressure P2 can be done based on one or more parameters, the one or more parameters comprising one or more of the following parameters:

composition of the methane comprising stream,

density of the methane comprising slush,

temperature of the methane comprising slush,

pressure inside the slush vessel.

When the pressure/temperature in the slush vessel is above the triple point, no solids are generated. When the pressure/temperature in the slush vessel 300 is below the triple point a relatively high solid fraction is generated. As the desired solid fraction in the methane comprising slush 40 may be lower than the solid fraction generated when operating below the triple point, the pressure in the slush vessel may be cycled between above and below the triple point, to obtain the desired solid fraction.

When the pressure in the slush vessel is cycled to above the triple point pressure, no solids are formed. When the pressure in the slush vessel is cycled to the triple point pressure or below the triple point pressure, solid particles, liquids and vapour are formed together with typically a solid fraction of 70%. As a solid fraction of 70% is typically too high for pumping the methane comprising slush, cycling is applied to create a methane comprising slush with a lower solid fraction, preferably a solid fraction in the range of 30-70 weight %, preferably in the range of 30-50 weight % or 40-60 weight %. This way the second pressure can be varied slightly to control the solid fraction in the slush vessel.

Controlling the second pressure may be done by controlling the compressor 302 withdrawing the vapour stream 303 from the top outlet 3001 of the slush vessel 300 kept at the second pressure P2, such as controlling the settings of the compressor (revolutions per minute, power).

Controlling the second pressure P2 may be done by controlling the eductor 304 withdrawing the vapour stream 303 from the top outlet 3001 of the slush vessel 300 kept at the second pressure P2, for instance by controlling the flow rate of the motive stream to the eductor 304. Controlling the flow rate of the motive stream 30′ may be done by controlling splitter 31.

In case the solid fraction in the slush vessel falls below a predetermined threshold, the compressor may be controlled to lower the second pressure to a value below the triple point pressure such that new solids are formed thereby increasing the solid fraction in the slush vessel.

In case the solid fraction in the slush vessel exceeds a predetermined threshold, the compressor may be controlled to increase the second pressure to a value above the triple point pressure such that less or no new solids are formed thereby decreasing the solid fraction in the slush vessel.

According to an embodiment the liquid methane comprising stream 30 at the first pressure P1 is passed to the slush vessel 300 which is kept at the second pressure P2 via at least one intermediate stage 310, 320, each intermediate stage having a respective intermediate pressure (Pᵢₙₜ₁, Pᵢₙₜ₂).

The intermediate pressure Pᵢₙₜ₁: P₁>Pᵢₙₜ₁>P₂. Each intermediate stage may comprise an intermediate vessel 310, 320. However, subsequent intermediate stages may also be integrated into a single vessel having different compartments.

In case one intermediate vessel is applied, the liquid methane comprising stream is passed to the intermediate vessel via a conduit comprising a valve, preferably a Joule-Thompson valve, to reduce the pressure from the first pressure to the intermediate pressure. A liquid bottom stream is obtained from the intermediate vessel which is passed to the slush vessel kept at the second pressure via a conduit comprising a second valve, for example a Joule-Thompson valve, to reduce the pressure from the intermediate pressure to the second pressure.

In case more than one intermediate stages or vessels is applied, the intermediate vessels are placed in series, each subsequent intermediate vessel receiving a liquid bottom stream from the intermediate vessel directly upstream thereof via a conduit comprising a valve, for example a Joule-Thompson or throttle valve to let down the pressure. For instance, in case two intermediate vessels are used, the first intermediate vessel may have a first intermediate pressure Pᵢₙₜ₁, the second intermediate vessel may have a second intermediate pressure Pᵢₙₜ₂: P₁>Pᵢₙₜ₁>Pᵢₙₜ₂>P₂.

According to an example, the P₁=1 bar, Pᵢₙₜ₁=0.66 bar, Pᵢₙₜ₂=0.22 bar, P₂ being substantially equal to the triple point pressure for the composition being processed.

According to an embodiment the method further comprises

withdrawing a vapour stream from a top outlet of the slush vessel 300 kept at the second pressure P2,

withdrawing one or more vapour streams 312, 322 from respective top outlets of the at least one intermediate vessel 310, 320, and

combining the vapour streams from the slush vessel 300 and the at least one intermediate vessel 300.

All vapour streams may be withdrawn from the respective vessels using one and the same compressor or pump 302, having different inlets 3024, 3023, 3021 for the different vapour streams. The compressor or pump 302 generates a combined vapour outlet stream 305.

An embodiment is schematically shown in FIG. 2, comprising two intermediate stages/vessels 310, 320.

A first intermediate vessel 310 comprises an inlet 3103 which is in fluid communication with conduit 30 via a Joule-Thompson or throttle valve 311. The first intermediate pressure Pᵢₙₜ₁ is thus smaller than the first pressure P₁: P₁>Pᵢₙₜ₁.

The first intermediate vessel 310 comprises a bottom outlet 3102 which is in fluid communication, via a second Joule-Thompson or throttle valve 321, with an inlet 3203 of the second intermediate vessel 320.

The first intermediate vessel 310 comprises a top outlet 3101 which is in fluid communication with compressor 302 (or with eductor 304 (not shown)) via first intermediate compressor inlet 3024.

The second intermediate vessel 320 comprises a bottom outlet 3202 which is in fluid communication with the slush vessel 300, via the one or more parallel throttle valves or spray nozzles 301.

The second intermediate vessel 320 comprises a top outlet 3201 which is in fluid communication with compressor 302 (or with eductor 304 (not shown)) via second intermediate compressor inlet 3023.

The top outlet 3001 of the slush vessel 300 is in fluid communication with the compressor 302 via main compressor inlet 3021 (or with eductor 304 (not shown)).

According to an embodiment providing the liquid methane comprising stream 30 at a first pressure P1 comprises obtaining the liquid methane comprising stream 30 directly from a liquefaction plant 100 comprising one or more cooling stages, the liquefaction plant 100 being arranged to liquefy a methane comprising stream or comprises obtaining the liquid methane comprising stream 30 directly from a storage tank 200 which is in fluid communication with the liquefaction plant 100.

The term directly is used to indicate that the stream is obtained without intermediate transport or shipping using a LNG carrier vehicle or vessel. It will be understood that a conduit of a certain length is needed to cover the distance between the liquefaction plant 100 or storage tank and the slush vessel 300. This distance may need to meet certain safety regulations, but is typically smaller than 500 meters, preferably smaller than 250 meters.

The liquid methane comprising stream may be obtained as a bottom stream from an end flash stage of a liquefaction plant or directly from a final cooling stage of a liquefaction plant, for instance from a main cryogenic heat exchanger.

According to this last option obtaining the liquid methane comprising stream 30 directly from a liquefaction plant 100 comprises obtaining the liquid methane comprising stream 30 directly from a cooling stages in which the methane comprising stream is cooled against a refrigerant. This does thus not include an end-flash stage.

The end-flash could be omitted and the vapour stream obtained from the top outlet of the slush vessel 300 would then be relatively large. A splitter may be provided to split the vapour stream into a fuel portion which is supplied to the fuel system to fuel consuming devices of the liquefaction plant or a fuel tank and a main part, which is recycled to one or more cooling stages as described below with reference to FIGS. 3a and 4. The split ratio between the fuel portion and the main part can be actively and constantly controlled and adjusted.

FIG. 3a schematically depicts a liquefaction plant in which a gaseous methane comprising stream 10 is liquefied to obtain the liquid methane comprising stream 30. The liquefaction process may comprise generating a liquid methane comprising stream by:

optionally treating the methane comprising stream by removing impurities in a treating stage 101,

optionally removing natural gas liquids from the methane comprising stream in a NGL stage 102,

cooling the methane comprising stream in one or more cooling stages 103, in particular a pre-cooling stage and a main cooling stage, and

optionally flashing the methane comprising stream in an end-flash stage 104.

In the treating stage 101 impurities are removed from the stream 10, such as water, acid gases, mercury.

In the NGL stage 102 a vast portion of the natural gas liquids are removed from the stream 10 such as ethane, propane, butane and heavier components.

In the cooling stage 103, the methane comprising stream 10 is cooled.

The flashing stage 104, also referred to as an end-flash stage, may comprise an end flash vessel and throttle valve to reduce the pressure and temperature of the stream and allow the lighter components to be flashed.

It will be understood that these stages are not necessary separated, successive stages, but that some level of integration between the different stages may be achieved. The NGL stage may be embedded in the cooling stage, for instance by withdrawing a NGL feed stream from the process stream 10 in between subsequent cooling stages.

Shown in FIG. 3b, the liquefied natural gas is stored in a storage tank 200, which is in fluid communication with the liquefaction plant 100.

The liquid methane comprising stream 30 at the first pressure P₁ may be obtained from the main cooling stage or may be obtained from the end-flash stage 104 or may be obtained from the storage tank 200.

According to an embodiment the method further comprises withdrawing a vaporous top stream 303 from the slush vessel 300 and recycling the vaporous top stream 303 to the one or more cooling stages. This is schematically depicted in FIG. 3a.

The vaporous top stream 303 may be recycled to the pre-cooling stage and via the pre-cooling stage to the main cooling stage, or may be recycled to the main cooling stage directly (not shown).

FIG. 3b shows that the vaporous top stream 303 is combined with a boil-off stream 201 obtained from the storage tank 200. The combined stream 306 may be used as fuel for refrigerant compressors and/or fuel for generating electricity or steam, and/or can be recycled to the pre-cooling or cooling stages of the upstream liquefaction process.

FIG. 4 schematically shows an embodiment in which the vaporous top stream 303 is recycled to the pre-cooling stage 103a and subsequently to the main cooling stage 103b.

FIG. 4 shows gaseous methane comprising stream 10 being passed through treating stage 101 and NGL stage 102. These stages are shown schematically and it will be understood that some level of integration with other stages may be present. In particular NGL stage 102 may be integrated into the cooling stage 103.

FIG. 4 shows a pre-cool stage 103a and a main cool stage 103b. For reasons of clarity, the refrigerant cycles are not depicted.

The pre-cool stage 103a may comprise a first heat exchanger 1031 to cool the stream 10 against the first refrigerant. The first heat exchanger 1031 may comprise one or more, parallel or serial, sub-heat exchangers (not shown). The gaseous methane comprising stream 10 enters the pre-cool stage 103a via inlet 1030 to be cooled against a first refrigerant and leaves the pre-cool stage 103a via outlet 1033.

The main cooling stage 103b comprises a heat exchanger 1039 also referred to as the main cryogenic heat exchanger 1039.

An inlet 1035 of the main cryogenic heat exchanger 1039 is in fluid communication with outlet 1033 of the pre-cool stage 103a to receive the pre-cooled stream from the pre-cool stage 103a to further cool the stream 10 against a second refrigerant in a main cooling stage 103b generating a cooled methane comprising stream. The cooled methane comprising stream leaves the main cooling stage 103b via outlet 1037.

FIG. 4 further shows conduit 305 which is with one end in fluid communication with compressor 302 (or eductor 304 (not shown)) via compressor outlet 3022 to receive a compressed vaporous top stream, and with another end in fluid connection with pre-cool stage 103a to recycle the vaporous top stream to the pre-cooling stage. The compressor 302 may be an intercooled compressor 302.

The conduit 305 conveying the compressed vaporous top stream 305 received from the compressor 302 may comprise a cooler 307, preferably an ambient cooler, to cool the compressed vaporous top stream 305 against an ambient stream, such as an ambient water or air stream, to produce cooled compressed vaporous top stream 305′.

As shown in FIG. 4, pre-cool stage 103a comprises a second heat exchanger 1032 in fluid communication with the conduit 305 to receive the compressed vaporous top stream via 1032 via inlet 1029 and to generate a cooled top stream.

The first and second heat exchangers 1031, 1032 function in parallel and may operate at different pressures. The second heat exchanger 1032 may operate at a lower pressure than the first heat exchanger 1031 as the pressure of the cooled compressed vaporous top stream 305′ is typically lower than the gaseous methane comprising stream 10 being passed through treating stage 101 and NGL stage 102.

The first and second heat exchangers 1031, 1032 may also be integrated into a single heat exchanger having parallel flow paths for the compressed vaporous top stream 305 and the stream 10.

The second heat exchanger 1032 may comprise one or more, parallel or serial, sub-heat exchangers (not shown).

An inlet 1036 of the main cryogenic heat exchanger 1039 is in fluid communication with outlet 1034 of the second heat exchanger 1023 of the pre-cool stage 103a to receive the pre-cooled top stream to further cool the pre-cooled top stream against the second refrigerant in the main cooling stage 103b generating a cooled top stream. The cooled top stream leaves the main cryogenic heat exchanger 1039 via outlet 1038.

Both the cooled methane comprising stream and the cooled top stream are flashed in parallel throttle or Joule-Thompson valves 1042 before being recombined and passed to slush vessel 300.

So, according to an embodiment the one or more cooling stages are operated to cool the methane comprising stream in

a pre-cool stage 103a against a first refrigerant,

a main cooling stage 103b against a second refrigerant generating a cooled methane comprising stream,

the method further comprises

compressing the vaporous top stream generating a compressed vaporous top stream,

optionally cooling the compressed vaporous top stream against the first refrigerant generating a pre-cooled top stream,

cooling the pre-cooled vaporous stream against the second refrigerant generating a cooled top stream,

wherein the method further comprises combining the cooled top stream with the cooled methane comprising stream.

The first refrigerant may be a single component refrigerant, for instance propane. The first refrigerant may alternatively be a mixed refrigerant comprising two or more components, such as ethane, propane, butane.

The second refrigerant may be a mixed refrigerant comprising two or more components, such as ethane, propane, butane. The average molecular weight of the first refrigerant is higher than the average molecular weight of the second refrigerant.

The main cooling stage 103b generates a cooled methane comprising stream which is liquefied or at least partially liquefied. In an embodiment wherein the liquid methane comprising stream at the first pressure is passed to the slush vessel which is kept at the second pressure via at least one intermediate vessel having an intermediate pressure and the vapour streams 312, 322 from respective top outlets of the intermediate vessels 310, 320 and from the slush vessel 300 are combined resulting in a combined vaporous stream, the combined vaporous stream is compressed, pre-cooled and further cooled similar to as explained above with reference to FIG. 4.

Pre-cooling the vaporous top stream against the first refrigerant and main cooling the pre-cooled vaporous stream against the second refrigerant obtaining a cooled liquefied stream may be done at a different pressure than pre-cooling and main cooling the methane comprising stream obtaining the cooled methane comprising stream. Before combining the cooled liquefied stream and the cooled methane comprising stream the pressures are to be equalized.

According to an embodiment providing the liquid methane comprising stream 30 at a first pressure P1 and passing the liquid methane comprising stream 30 to the slush vessel 300 which is kept at a second pressure P2 are performed simultaneously and continuously.

The providing of the liquid methane comprising stream at a first pressure and the passing the liquid methane comprising stream to the slush vessel may be performed simultaneously. These steps are thus not performed in a batch-wise manner. Of course, these steps will be interrupted from time to time, for instance for maintenance purposes, but during operation these steps are performed simultaneously and continuously.

The person skilled in the art will understand that the present invention can be carried out in many various ways without departing from the scope of the appended claims.

1. Method of partially solidifying a methane comprising stream, the method comprising
providing a liquid methane comprising stream at a first pressure (P1),
passing the liquid methane comprising stream to a slush vessel which is kept at a second pressure (P2), the second pressure (P2) being lower than the first pressure (P1), thereby cooling and at least partially solidifying the methane comprising stream generating a methane comprising slush, the slush comprising solid methane and liquid methane and
collecting the methane comprising slush.

2. Method according to claim 1, wherein the second pressure (P2) in the slush vessel is substantially equal to or lower than the triple point pressure of the methane comprising stream.

3. Method according to claim 1, wherein passing the liquid methane comprising stream to the slush vessel which is kept at the second pressure (P2) is done by spray cooling the methane comprising stream.

4. Method according to claim 1, wherein the method comprises
withdrawing a vapour stream from a top outlet of the slush vessel using a vapour withdrawing device, such as a compressor and/or an eductor.

5. Method according to claim 1, wherein the second pressure (P2) is controlled to control a solid fraction of the mixture of solid methane comprising hydrocarbon and liquid methane comprising hydrocarbon in the slush vessel.

6. Method according to claim 1, wherein the liquid methane comprising stream at the first pressure (P1) is passed to the slush vessel) which is kept at the second pressure (P2) via at least one intermediate stage, each intermediate stage having an respective intermediate pressure (Pᵢₙₜ₁, Pᵢₙₜ₂).

7. Method according to claim 6, wherein the method further comprises
withdrawing a vapour stream from a top outlet of the slush vessel kept at the second pressure (P2),
withdrawing one or more vapour streams from respective top outlets of the at least one intermediate vessel, and
combining the vapour streams from the slush vessel and the at least one intermediate vessel.

8. Method according to claim 1, wherein providing the liquid methane comprising stream at a first pressure (P1) comprises obtaining the liquid methane comprising stream directly from a liquefaction plant comprising one or more cooling stages, the liquefaction plant being arranged to liquefy a methane comprising stream or comprises obtaining the liquid methane comprising stream directly from a storage tank which is in fluid communication with the liquefaction plant.

9. Method according to claim 8, wherein the method further comprises withdrawing a vaporous top stream from the slush vessel and recycling the vaporous top stream to the one or more cooling stages.

10. Method according to claim 8, wherein the one or more cooling stages are operated to cool the methane comprising stream in
a pre-cool stage against a first refrigerant,
a main cooling stage against a second refrigerant generating a cooled methane comprising stream,
the method further comprises
compressing the vaporous top stream generating a compressed vaporous top stream,
optionally cooling the compressed vaporous top stream against the first refrigerant generating a pre-cooled top stream,
cooling the pre-cooled vaporous stream against the second refrigerant generating a cooled top stream,
wherein the method further comprises combining the cooled top stream with the cooled methane comprising stream.

11. Method according to claim 8, wherein obtaining the liquid methane comprising stream directly from a liquefaction plant comprises obtaining the liquid methane comprising stream directly from a cooling stages in which the methane comprising stream is cooled against a refrigerant.

12. Method according to claim 1, wherein providing the liquid methane comprising stream at a first pressure (P1) and passing the liquid methane comprising stream to the slush vessel which is kept at a second pressure (P2) are performed simultaneously and continuously.

13. Method according to claim 1, wherein the solid fraction of the methane comprising slush is controlled by applying one or more of the following:
diluting the methane comprising slush obtained in the slush vessel by introducing a liquid methane comprising stream,
diluting the methane comprising slush obtained in the slush vessel by introducing a sub-cooled liquid methane comprising stream,
actively controlling the second pressure (P2), in particular cycling the second pressure (P2) above and below the triple point pressure of the methane comprising stream,
actively controlling the first pressure (P1),
actively controlling the flow rate of a vapour stream withdrawn from a top outlet of the slush vessel using a vapour withdrawing device.

14. Apparatus for partially solidifying a methane comprising stream, the apparatus comprising
a feed conduit arranged to receive a liquid methane comprising stream at a first pressure (P1),
a slush vessel which is in fluid communication with the feed conduit to receive the liquid methane comprising stream,
a vapour withdrawing device being in fluid communication with the slush vessel to withdraw vapour from the slush vessel and keep the slush vessel at a second pressure (P2), the second pressure (P2) being lower than the first pressure (P1), and the second pressure being substantially equal to or lower than the triple point pressure of the methane comprising stream.

15. Apparatus according to claim 14, the apparatus comprising one or more throttle valves or spray nozzles positioned in the slush vessel to receive the liquid methane comprising stream from the feed conduit and spray cool the methane comprising stream into the slush vessel.

16. Apparatus according to claim 14, wherein the slush vessel comprises an internal mixer.
